(19) United States
(12) Patent Application Publication
(10) Pub. No.: US 2010/0326043 A1
(43) Pub. Date: Dec. 30, 2010

(54) Expander cycle rocket engine nozzle

(75) Inventor: Philip C. Pelfrey, Boca Raton, FL (US)

Correspondence Address: JOHN RYZNIC, FLORIDA TURBINE TECHNOLOGIES, INC., 1701 MILITARY TRAIL, SUITE 110, JUPITER, FL, 33458-7887, US

(73) Assignee: Florida Turbine Technologies, Inc., Jupiter, FL (US)

(21) Appl. No.: 11/700,800

(22) Filed: Jan. 31, 2007

(51) Int. Cl. F02K 9/00; F02K 99/00

(52) U.S. Cl. 60/205; 60/266

(57) ABSTRACT

An expander cycle rocket engine includes a primary nozzle with a heat exchanger formed therein to cool the nozzle and heat up a fluid used to drive a turbo-pump, and a secondary heat exchanger is located within the primary nozzle and includes passages to channel the fluid in order to add additional heat to the fluid used to drive the turbo-pump. The secondary heat exchanger can be a nozzle shaped heat exchanger located within the primary nozzle, and struts that secure the nozzle shaped heat exchanger within the primary nozzle and channel the fluid between nozzles. The concentric arrangement of first and second heat exchangers can transfer more heat from the combustion gases to the fluid that is used to drive the turbo-pump such that higher pressures can be obtained allowing for larger nozzles and much higher thrust than can be obtained with traditional nozzle engines, or provide significantly higher chamber pressures for engines in the prior art thrust class.

### BACKGROUND OF THE INVENTION

1. Field of the Invention

The present invention relates generally to power plants, and more specifically to an expander cycle rocket engine nozzle.

2. Description of the Related Art Including Information Disclosed Under 37 CFR 1.97 and 1.98

Rocket engines that use cryogenic fuels and oxidizers such as a gas generator cycle and the staged combustion cycle rocket engines use some of the fuel and oxidizer to pre burn and drive the turbo-pumps that deliver the high pressures to the engine nozzle. In the gas generator cycle, a very small portion of the fuel and the oxidizer is bled off from that delivered to the main combustion chamber (MCC) and diverted into a small pre-burner and combusted to produce a hot gas flow that is then used to drive the turbo-pumps that supply the high pressure fuel and oxidizer to the main combustion chamber. The exhaust gas from the turbo-pumps is then vented overboard. In the staged combustion cycle, a small portion of the propellant (either the oxidizer or the fuel) is diverted and combined with all of the other propellant to partially combust the combination, which is then passed through the turbo-pumps to drive these. This mixture is then sent to the main combustion chamber along with the remainder of the propellant and is combusted in the main combustion chamber. In both the gas generator and staged combustion cycles, some of the fuel and oxidizer is used to produce power to drive the turbo-pumps and therefore not used to produce power in the rocker engine nozzle. Also, because of the high turbo-pump inlet temperature, the turbine driving the turbo-pump is subject to thermal shock and thermal mechanical failure, or TMF.

An expander cycle rocket engine passes a propellant (typically the fuel) through a heat exchanger formed within or around the nozzle to transfer heat from the combustion process in the nozzle to the fuel to heat up the fuel. The heated fuel (in the case of most cryogenic fuels and oxidizers is hydrogen) is passed through the turbines that drive the turbo-pumps to pressurize the fuel and the oxidizer prior to injection into the main combustion chamber for combustion. The expander cycle is more efficient than either of the gas generator and staged combustion cycles because all of the fuel and oxidizer is used in combustion and exhausted through the throat and then into the nozzle for expansion. The expander cycle rocket engine has many advantages over the staged combustion and gas generator cycles. Rather than using a pre-burner, the engine routes liquid propellant from the pump discharge to the nozzle. This flow cools the nozzle and heats up the liquid turning it into a gas. The high pressure gas is then routed to the turbine inlet to drive the turbo-pump(s). The turbine is driven by gas expanded from heat transfer in the engine nozzle rather than from products of combustion from a pre-burner as used in the gas generator and staged combustion engine cycles. As a result, the turbine temperature is significantly lower than for the other cycles resulting is longer life due to the elimination of thermal shock and thermal mechanical fatigue (TMF). The expander cycle rocket engine has proven to be the most reliable engine and has demonstrated superior re-start capability. However, in prior art expander cycle rocket engines, the thrust this engine is capable of producing has reached a maximum limit. As the size of the nozzle increases, the engine mass flow increases at a greater rate than the surface area of the nozzle. As a result, a limit is reached when there is insufficient heat transfer in the nozzle to drive the turbo-pump(s) required to provide the mass flow to the engine. Additionally, for a given mass flow, the chamber pressure is also limited based on the turbine power available for driving the turbo-pumps

High thrust (in excess of 100,000 pounds) expander cycle rocket engines have traditionally been limited to a chamber pressure below 1,500 psia because of a lack of turbine power available to the fuel turbo-pump. In a typical expander cycle rocket engine, fuel from the fuel turbo-pump is pumped through the cooling liner and tubular nozzle of the engine's nozzle assembly where the fuel is heated and then fed to a turbine which drives the turbo-pumps. In order to increase the combustion chamber pressure, flow to the combustion chamber must be increased. However, as fuel flow through the cooling liner and tubular nozzle increases, the temperature of the fuel at the turbo-pump turbine inlet decreases due to the increase in mass flow rate of the fuel or to provide higher discharge pressure. At the same time, the fuel turbo-pump must do more work to provide the increased mass flow rate of the fuel. Although the energy available to the fuel turbo-pump turbine is a function of both the mass flow rate of the fuel and the turbine inlet temperature, the increase in the mass flow rate of fuel cannot offset the resulting decrease in turbine inlet temperature which occurs as a result of the increased fuel flow rate. Consequently, the decrease in turbine inlet temperature and the increase in work required by the turbo-pump at the higher fuel flow rates act to limit the maximum fuel flow rate to the combustion chamber, thereby limiting combustion chamber pressure.

In summary, the expander cycle rocket engine uses heat from the nozzle to heat up the fuel to drive the turbo-pumps that pressurized the fuel and oxidizer for combustion in the nozzle (combustion chamber). To increase the thrust of the rocket engine, a larger propellant flow and/or discharge pressure is required. As the engine/nozzle size increases, the propellant volume increases faster than the surface area of the nozzle. As the nozzle volume increases and more fuel and oxidizer is needed to be pressurized, the amount of heat transferred to the fuel for driving the turbo-pumps becomes less than required to supply the higher pressures. As a result of increasing the nozzle volume, the efficiency of the expander cycle rocket engine becomes less and less. There is a limit in nozzle size using the present technologies because of this effect.

It is therefore an object of the present invention to provide for an expander cycle rocket engine that can have a higher thrust or a higher chamber pressure than available in the cited prior art.

### BRIEF SUMMARY OF THE INVENTION

The present invention is nozzle assembly for an expander cycle rocket engine in which the nozzle assembly includes an primary nozzle of prior art design and an inner nozzle shaped heat exchanger formed concentric with the primary nozzle, and in which both the primary nozzle and the nozzle shaped heat exchanger include heat transfer passages in which the fuel is passed to cool the heat exchanger and to extract heat from the combustion gases in the nozzle. Because of the concentric nozzle arrangement, more heat can be extracted from the combustion gases and used to drive the turbo-pumps to supply the required higher pressure to the fuel and oxidizer supplied to the main combustion chamber. The inner nozzle shaped heat exchanger is secured in place by flow entrance and exit struts that pass the fuel between the primary nozzle and the nozzle shaped heat exchanger (the inner nozzle). The inner nozzle conforms to the flow of the combustion gas within the primary (outer) nozzle so as not to block the exhaust gas flow.

### BRIEF DESCRIPTION OF THE SEVERAL VIEWS OF THE DRAWINGS

FIG. 1 shows a prior art nozzle used in an expander cycle rocket engine.

FIG. 2 shows the prior art outer nozzle with the inner nozzle secured within of the present invention.

FIG. 3 shows a cut-away view of the outer and inner nozzles and the fuel flow strut arrangement.

FIG. 4 shows a bottom view of the twin nozzle arrangement of the present invention.

### DETAILED DESCRIPTION OF THE INVENTION

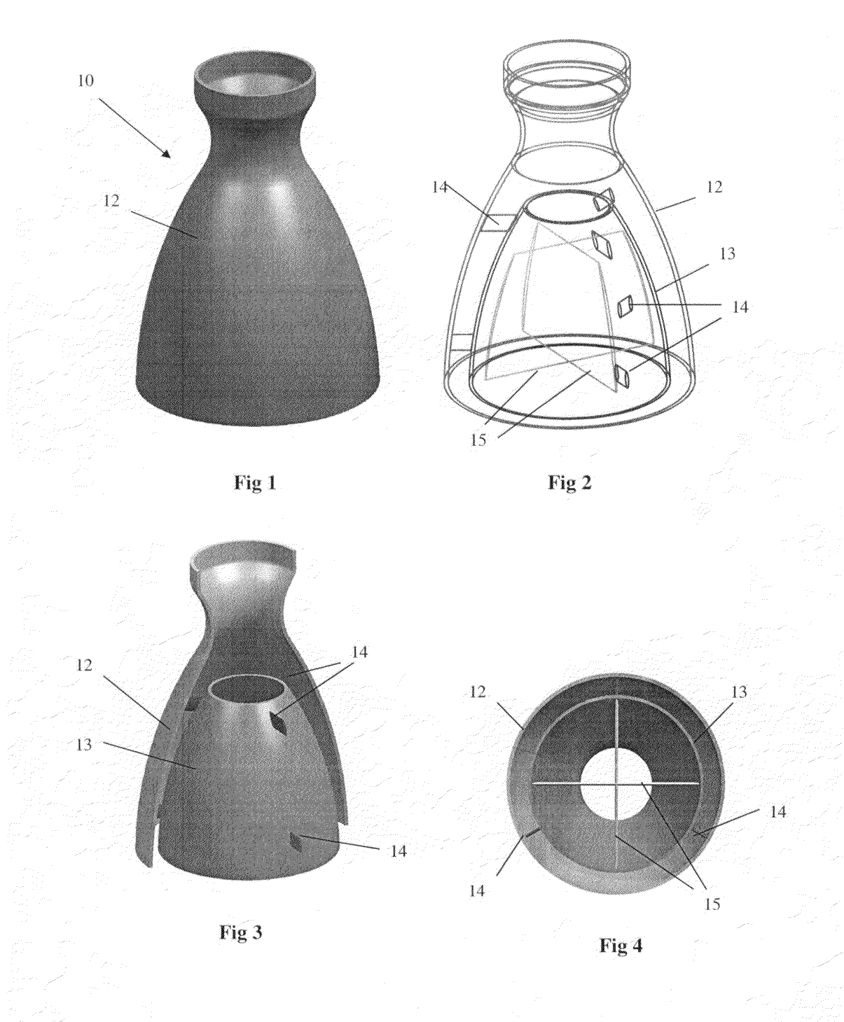

The present invention is a nozzle assembly for use in an expander cycle rocket engine. FIG. 1 shows a prior art expander cycle nozzle 10 which also forms part nozzle assembly of the present invention. The nozzle 12 has a throat and an expander portion downstream from the throat. The nozzle 12 also includes tubing or passages formed within the nozzle walls to pass the fuel or the oxidizer to transfer heat from the combustion gases flowing through the nozzle which is used to drive one or both of the turbo-pumps that supply the pressurized fuel (e.g., hydrogen) or oxidizer (e.g., oxygen) to the nozzle for combustion.

FIG. 2 shows the nozzle assembly of the present invention in which an inner nozzle shaped heat exchanger (inner nozzle) 13 is secured within the primary (outer) nozzle 12 by struts 14 that pass from the primary nozzle 12 to the inner nozzle 13. The inner nozzle 13 also has tubing or passages formed within the walls of the inner nozzle 13 in which the liquid fuel is passes as in the primary nozzle 12. The struts that secure the inner nozzle 12 within the primary nozzle 12 also have fluid passages to carry the fluid between the inner nozzle and the outer nozzle. The struts 14 have an airfoil shape to reduce a drag force as the combustion gases flow around the struts during operation of the engine. In the present embodiment, three lower struts extend between a lower portion of the nozzles and three upper struts extend between upper portions of the two nozzles to secure the nozzle assembly. In other embodiments, more than three struts on each of the lower and the upper portions can be used depending upon the strength provided by the extra struts. The inner nozzle 13 also conforms to the combustion gas flow through the outer nozzle so as to reduce the drag from locating the inner nozzle within the combustion gas flow. The inner nozzle 13 functions to extract more heat from the combustion gases flowing through the outer nozzle 12 than would the outer nozzle 12 used by itself.

In an alternate embodiment, cross fins 15 can be includes within the inner nozzle 13 that also function to pass the liquid fuel to extract more heat from the combustion gases flowing through the nozzles. The cross fins 15 can be used with the inner nozzle 13 and extend between the inner nozzle 13, or the cross fins 15 can be used without the inner nozzle 13 and extend between the outer nozzle 12 to provide heat transfer from the combustion gases flowing to the liquid passing through the cross fins 15. also, in another embodiment of the cross fins 15, the cross fins 15 could have slots or openings formed across the two side of the fins in order to equalize the pressures acting on the fins to limit flexing of the fins during engine operation. The fluid passages through the cross fins 15 would be closed off from these openings to equalize pressures.

Operation of the nozzle assembly for the expander cycle rocket engine of the present invention is described below. One of the cryogenic liquids used for combustion (typically the hydrogen in a hydrogen oxygen combustion because the liquid hydrogen has the highest heat transfer coefficient of the two liquids) is passed through the primary or outer nozzle from bottom to top in order to cool the primary nozzle and heat up the liquid hydrogen. Some of the liquid hydrogen is also passed through the lower struts and into the inner nozzle and flows from bottom to top in order to also cool the inner nozzle and heat up the liquid hydrogen passing through. The heated up hydrogen then flows out from the inner nozzle through the upper struts to be joined with the heated up hydrogen leaving the primary or outer nozzle. The heated up hydrogen from both nozzles then flows through one or both of the turbo-pumps to pressurize one or both of the fuel and oxidizer for delivery to the combustion chamber within the nozzle assembly.

Use of the additional nozzle in the expander cycle rocket engine increases the available surface area of the nozzle assembly to provide the additional heat transfer necessary to drive the turbo-pumps for a higher mass flow required for higher pressures and higher thrust than is available using the prior art nozzle. The internal nozzle heat exchanger is substantially similar to the tubular heat exchanger used to cool the primary or outer nozzle. Its diameter and length is based on the magnitude of the additional heat transfer required. A plurality of struts attaches the internal heat exchange nozzle to the outer primary nozzle. The liquid propellant enters and exits the internal heat exchanger through ports contained within the struts. Multiple concentric internal heat exchangers could be used if required by engine sizing in other embodiments. Alternate embodiments using non-concentric, asymmetric or other geometries are also considered to be within the possible configurations of the present invention. In each embodiment, the primary flow path of the nozzle is unaffected. The envelope of the nozzle is adjusted as necessary to maintain the desired cross-sectional area of the primary flow path within the nozzle. However, the overall size, length and area ratio remain optimum. The internal heat exchanger elements are oriented along streamlines of the flow and the struts are aerodynamically shaped to mitigate any flow disturbances. The present invention removes the current thrust limitations of an expander cycle rocket engine and allows for engine designs of any thrust.

In an expander cycle rocket engine, liquid hydrogen is typically the fuel and liquid oxygen is typically the oxidizer. In this case, the liquid hydrogen is the fluid that is passed through the heat exchangers to cool the nozzles and drive the turbo-pump because the hydrogen has a greater coefficient of heat than does the oxygen. Because of the twin nozzle assembly of the present invention, a different fuel could be used such as kerosene, which is a much less volatile fuel than hydrogen. With kerosene as the fuel, liquid oxygen would be the oxidizer. In this case, the oxygen would have the higher heat capacity that the kerosene. As such, the liquid oxygen would be the fluid passed through the heat exchangers and used to drive the turbo-pump. The present invention is independent of the propellants selected for use in the engine.

I claim the following:

1. A rocket nozzle assembly for use in an expander cycle rocket engine, the nozzle assembly comprising:
A primary nozzle forming an outer heat exchanger for a fluid, the primary nozzle forming an expansion chamber for a combustion gas flow; and,
An inner heat exchanger located within the primary nozzle for heating a fluid passing through the inner heat exchanger.

2. The rocket nozzle assembly of claim 1, and further comprising:
The inner heat exchanger is a nozzle shaped heat exchanger.

3. The rocket nozzle assembly of claim 2, and further comprising:
A plurality of struts securing the inner nozzle shaped heat exchanger within the primary nozzle, the struts also forming a fluid passage between the two nozzles.

4. The rocket nozzle assembly of claim 3, and further comprising:
The struts are aerodynamically shaped to mitigate flow disturbances in the primary nozzle.

5. The rocket nozzle assembly of claim 1, and further comprising:
A throat and a main combustion chamber located upstream of the primary nozzle; and,
The inlet of the inner nozzle shaped heat exchanger is located downstream from the throat.

6. The rocket nozzle assembly of claim 5, and further comprising:
A contour of the inner nozzle shaped heat exchanger substantially follows streamlines of flow through the primary nozzle.

7. The rocket nozzle assembly of claim 5, and further comprising:
The outlets opening of both nozzles are on substantially the same plane.

8. The rocket nozzle assembly of claim 1, and further comprising:
The inner heat exchanger comprising at least one cross fin extending across the primary nozzle and forming a fluid passage such that the fluid is heated due to the combustion gas flow through the primary nozzle.

9. The rocket nozzle assembly of claim 8, and further comprising:
The cross fin includes a plurality of openings to limit a differential pressure formed across the two sides of the cross fin.

10. The rocket nozzle assembly of claim 2, and further comprising:
The nozzle shaped heat exchanger includes a cross fin extending across the inner surface of the nozzle, the cross fin forming a fluid passage such that the fluid is heated due to the combustion gas flow through the primary nozzle.

11. An expander cycle rocket having a fuel and an oxidizer, and a primary nozzle with a combustion chamber and a throat to produce thrust, the rocket comprising:
A fuel turbo-pump to increase the pressure of the fuel for combustion in the combustion chamber;
An oxidizer turbo-pump to increase the pressure of the oxidizer for combustion in the combustion chamber;
The primary nozzle having a first heat exchanger to cool the primary nozzle and heat the fluid passing through the first heat exchanger;
Fuel communication means to connect the fuel turbo-pump with the first heat exchanger;
Oxidizer communication means to connect the oxidizer turbo-pump to the combustion chamber;
A turbine to drive the fuel turbo-pump;
Fuel communication means to connect the first heat exchanger to the turbine; and,
A second heat exchanger located within the primary nozzle to heat up the fuel to drive the turbine.

12. The expander cycle rocket of claim 11, and further comprising:
The second heat exchanger is a nozzle shaped heat exchanger located within the primary nozzle and having; and,
A fluid communication passage to channel fluid to and from the two heat exchangers.

13. The expander cycle rocket of claim 12, and further comprising:
The fluid communication passage is a plurality of struts that secure the nozzle shaped heat exchanger within the primary nozzle and channel the fuel between the two heat exchangers.

14. The expander cycle rocket of claim 12, and further comprising:
At least one cross fin extending across the nozzle shaped heat exchanger, the cross fin forming a third heat exchanger to transfer heat to the fuel to power the turbine.

15. The expander cycle rocket of claim 11, and further comprising:
The second heat exchanger is a cross fin extending across the primary nozzle, the cross fin includes a fluid passage formed therein such that a fluid passing through heats up from the combustion gases passing through the primary nozzle.

16. The expander cycle rocket of claim 12, and further comprising:
A contour of the nozzle shaped heat exchanger substantially follows streamlines of flow through the primary nozzle.

17. The expander cycle rocket of claim 12, and further comprising:
The outlets opening of both nozzles are one substantially the same plane.

18. The expander cycle rocket of claim 12, and further comprising:
The inlet of the nozzle shaped heat exchanger is located downstream from the throat.

19. A process for producing thrust in an expander cycle rocket engine comprising the steps of:
Passing one of a fuel and an oxidizer through a heat exchanger formed within a primary nozzle of the rocket to heat the fuel or oxidizer;
Passing a portion of the fuel or oxidizer through a second heat exchanger formed within the primary nozzle to heat up the portion of the fuel or oxidizer;
Passing the heated fuel or oxidizer from the two heat exchangers through a turbine to drive a turbo-pump to pressurize the fuel or oxidizer; and,
Passing the heated fuel or oxidizer and the other one of a fuel and an oxidizer into a combustion chamber to produce thrust.

20. The process for producing thrust in an expander cycle rocket engine of claim 19, and further comprising the step of:
The fuel is liquid hydrogen and the oxidizer is liquid oxygen, and the liquid hydrogen is passed through the heat exchangers to pick up heat and drive the turbine.

21. The process for producing thrust in an expander cycle rocket engine of claim 19, and further comprising the step of:
Passing the fuel or oxidizer through the two heat exchangers in a direction opposite to the flow of combustion gases passing through the primary nozzle.

22. The process for producing thrust in an expander cycle rocket engine of claim 19, and further comprising the step of:
The second heat exchanger is a nozzle shaped heat exchanger located within the primary nozzle, and the fuel or oxidizer is passed to the second heat exchanger through struts supporting the nozzle shaped heat exchanger within the primary nozzle.

23. The rocket nozzle assembly of claim 1, and further comprising:
The outer heat exchanger and the inner heat exchanger form a parallel fluid path between fluid passage into the primary nozzle and the fluid passage out of the primary nozzle.

24. The rocket nozzle assembly of claim 23, and further comprising:
The inlet passage to the primary nozzle is connected to a turbo-pump, and the outlet passage of the primary nozzle is connected to a turbine that drives the turbo-pump.

25. The process for producing thrust in an expander cycle rocket engine of claim 19, and further comprising the step of:
Pressurizing the fuel or oxidizer in a turbo-pump to produce a high pressure fluid;
Passing the high pressure fluid in parallel through the two heat exchangers to heat up the high pressure fluid; and,
Passing the heated fluid from the two parallel heat exchangers into a turbine that drives the turbo-pump.
